(19) United States
(12) Patent Application Publication
(10) Pub. No.: US 2014/0038058 A1
(43) Pub. Date: Feb. 6, 2014

(54) LITHIUM TITANIUM MIXED OXIDE

(71) Applicants: Michael Holzapfel, Kehl (DE); Gerhard Nuspl, Munchen (DE)

(72) Inventors: Michael Holzapfel, Kehl (DE); Gerhard Nuspl, Munchen (DE)

(73) Assignee: Clariant Produkte (Deutschland) GmbH, Frankfurt/Main (DE)

(21) Appl. No.: 14/000,996

(22) PCT Filed: Feb. 29, 2012
(86) PCT No.: PCT/EP2012/053447

§ 371 Date: Oct. 14, 2013

(30) Foreign Application Priority Data
Mar. 1, 2011 (DE) 10 2011 012 713.5

(51) Int. Cl. H01M 10/0562; C01D 15/02; H01M 10/0525

(52) U.S. Cl. CPC H01M 10/0562; H01M 10/0525; C01D 15/02
USPC 429/319; 429/322; 423/598; 252/182.1; 429/231.8

(57) ABSTRACT

A method is indicated for producing a lithium titanium mixed oxide, comprising the provision of a mixture of titanium dioxide and a lithium compound, calcining of the mixture, and grinding of the mixture in an atmosphere with a dew point <−50° C. A lithium titanium mixed oxide and a use of same are also indicated. In addition, an anode and a solid electrolyte for a secondary lithium-ion battery, as well as a corresponding secondary lithium-ion battery are provided.

### CROSS-REFERENCE TO RELATED APPLICATIONS

This application is a U.S. National Stage application, claiming benefit under 35 U.S.C. §120 and 365 of International Application No. PCT/EP2012/053447, filed Feb. 29, 2012, and claiming benefit under 35 U.S.C. §119 of German Application No. 10 2011 012 713.5, filed Mar. 1, 2011, the entire disclosures of both prior applications being incorporated herein by reference in their entirety.

### BACKGROUND

The present invention relates to a method for producing a lithium titanium mixed oxide, a lithium titanium mixed oxide, a use of same and an anode, a solid electrolyte and a secondary lithium-ion battery containing the lithium titanium mixed oxide.

Mixed doped or non-doped lithium-metal oxides have become important as electrode materials in so-called “lithium-ion batteries”. For example, lithium-ion accumulators, also called secondary lithium-ion batteries, are regarded as promising battery models for battery-powered vehicles. Lithium-ion batteries are also used for example in power tools, computers and mobile telephones. In particular the cathodes and electrolytes, but also the anodes, consist of lithium-containing materials.

LiMn₂O₄ and LiCoO₂ for example are used as cathode materials. Goodenough et al. (U.S. Pat. No. 5,910,382) propose doped or non-doped mixed lithium transition metal phosphates, in particular LiFePO₄, as cathode material for lithium-ion batteries.

For example graphite or also, as mentioned above, lithium compounds, e.g. lithium titanates, can be used as anode materials in particular for large-capacity batteries.

Lithium salts are typically used for the solid electrolyte, also called solid-state electrolyte, of the secondary lithium-ion batteries. For example, lithium titanium phosphates are proposed as solid electrolytes in JP-A 1990-2-225310. Depending on the structure and doping, lithium titanium phosphates have an increased lithium-ion conductivity and a low electrical conductivity. This, and their great hardness, shows them to be suitable solid electrolytes in secondary lithium-ion batteries. A doping of the lithium titanium phosphates, for example with aluminium, magnesium, zinc, boron, scandium, yttrium and lanthanum, influences the ionic (lithium) conductivity of lithium titanium phosphates. In particular, the doping with aluminium leads to good results because, depending on the degree of doping, aluminium results in a high lithium-ion conductivity compared with other doping metals and, because of its cation radius (smaller than Ti⁴⁺), it can satisfactorily take the spaces occupied by the titanium in the crystal.

Lithium titanates, in particular lithium titanate Li₄Ti₅O₁₂, lithium titanium spinel, display some advantages compared with graphite as anode material in rechargeable lithium-ion batteries. For example, Li₄Ti₅O₁₂ has a better cycle stability, a higher thermal load capacity, as well as improved operational reliability compared with graphite. Lithium titanium spinel has a relatively constant potential difference of 1.55 V compared with lithium and passes through several thousand charge and discharge cycles with a loss of capacity of only <20%. Lithium titanate thus displays a much more positive potential than s graphite, and also a long life.

Lithium titanate Li₄Ti₅O₁₂ is typically produced by means of a solid-state reaction between a titanium compound, e.g. TiO₂, and a lithium compound, e.g. Li₂CO₃, at temperatures of over 750° C. (U.S. Pat. No. 5,545,468). The calcining at over 750° C. is carried out in order to obtain relatively pure, satisfactorily crystallizable Li₄Ti₅O₁₂, but this brings with it the disadvantage that excessively coarse primary particles form and a partial fusion of the material occurs. For this reason, the obtained product must be laboriously ground, which leads to further impurities. Typically, the high temperatures also often give rise to by-products, such as rutile or residues of anatase, which remain in the product (EP 1 722 439 A1).

Lithium titanium spinel can also be obtained by a so-called sol-gel method (DE 103 19 464 A1), wherein, however, more expensive titanium starting compounds must be used than with the production by means of solid-state reaction using TiO₂. Flame pyrolysis (Ernst, F. O. et al., Materials Chemistry and Physics 2007, 101 (2-3) pp. 372-378), as well as so-called “hydrothermal methods” in anhydrous media (Kalbac M. et al., Journal of Solid State Electrochemistry 2003, 8(1) pp. 2-6) are proposed as further production methods for lithium titanate.

Lithium transition metal phosphates for cathode materials can be produced e.g. by means of solid-state methods. EP 1 195 838 A2 describes such a method, in particular for producing LiFePO₄, wherein typically lithium phosphate and iron (II) phosphate are mixed and sintered at temperatures of approximately 600° C. The lithium transition metal phosphate obtained by solid-state methods is typically mixed with carbon black and processed to cathode formulations. WO 2008/062111 A2 furthermore describes a carbon-containing lithium iron phosphate which was produced by providing a lithium source, an iron (II) source, a phosphorus source, an oxygen source and a carbon source, wherein the method comprises a pyrolysis step for the carbon source. As a result of the pyrolysis, a carbon coating is formed on the surface of the lithium iron phosphate particle. EP 1 193 748 also describes so-called carbon composite materials of LiFePO₄ and amorphous carbon which, in the production of the iron phosphate, serves as reducing agent and serves to prevent the oxidation of Fe(II) to Fe(III). Moreover, the addition of carbon is to increase the conductivity of the lithium iron phosphate material in the cathode. It is indicated in EP 1 193 786 for example that only a level of not less than 3 wt.-% carbon in a lithium iron phosphate carbon material results in a desired capacity and corresponding cycle characteristics of the material.

However, the cycle life of a lithium-ion battery is also influenced by the moisture present therein. D. R. Simon et al. (Characterization of Proton exchanged Li₄Ti₅O₁₂ Spinel Material; Solid State Ionics: Proceedings of the 15th International Conference on Solid State Ionics, Part II, 2006. 177(26-32): pp. 2759-2768) describe for example that a lithium titanate, which was stored for 6 months in air, suffered a loss of capacity of 6%. The cycle stability of the stored lithium titanate, however, was not determined.

During the production of lithium titanium mixed oxides, such as for example lithium titanium spinel (LTO) or lithium aluminium titanium phosphate, there can always, at least at one point in time, be contact with normal ambient air. The material, in accordance with its large specific surface area of >1 m²/g, for fine-particle lithium titanate even approximately 10 m²/g, absorbs moisture, i.e. water from the air. This moisture absorption occurs very quickly, typically 500 ppm water is absorbed even after less than a minute and several 1000 ppm water is absorbed after one day. The moisture is first physisorbed on the surface and, during the subsequent drying, should be able to be easily removed again by baking at a temperature of >100° C. However, it was established that, in the case of anodes which contain lithium titanium mixed oxides, such as lithium titanium spinel and lithium aluminium titanium phosphate, the absorbed moisture cannot readily be removed again by baking. Batteries that contain anodes made of such materials, even when produced with the inclusion of a baking process, thus tend to form gas.

This undesired gas formation is possibly brought about by water chemisorbed in the lithium titanium mixed oxide. A chemisorption of the water adsorbed on the surface takes place relatively quickly under H⁺/Li⁺ exchange in a lithium titanium mixed oxide, such as lithium titanate or lithium aluminium titanium phosphate. The lithium is then found as Li₂O and/or Li₂CO₃ in the grain boundaries of the particles or at the surface of the particles. This effect occurs much more quickly than was previously described. Only a long subsequent drying at temperatures of for example more than 250° C. over 24 hours or more can remove the chemisorbed water again and make it possible to produce batteries that do not form gas during operation. However, water can be absorbed again during longer storage of the dried lithium titanium mixed oxide material or during longer storage and during operation of electrodes, solid electrolytes or batteries produced with it, and a gas formation in the batteries can result.

### SUMMARY

The object of the present invention was therefore to provide a lithium titanium mixed oxide with which electrodes, solid electrolytes and batteries, in particular secondary lithium-ion batteries, that are improved compared with known materials can be produced.

This object is achieved by a method for producing a lithium titanium mixed oxide, comprising the provision of a mixture of titanium dioxide and a lithium compound or provision of a lithium titanium composite oxide, calcining of the mixture or of the lithium titanium composite oxide, and grinding of the mixture in an atmosphere with a dew point <−50° C. The grinding takes place at room temperature.

It was surprisingly found that, by grinding a lithium titanium mixed oxide in an atmosphere with a dew point <−50° C., for example with dry air of such a dew point, a material can be obtained which makes it possible to produce lithium-ion batteries which display no or a substantially reduced gas formation, in particular during their operation.

### DETAILED DESCRIPTION

In an embodiment of the invention, the mixture can be ground in dry atmosphere with a dew point <−50° C. at the end of the production chain after the calcining. This results in a particularly suitable lithium titanium mixed oxide for the production of lithium-ion batteries, since the mixed oxide is less susceptible to water absorption during the calcining and during an optional grinding before the calcining. However, a step of grinding the mixture in the course of the production method, for example before the calcining of the mixture, can also be carried out in an atmosphere with a dew point <−50° C. in order to additionally reduce the water absorption.

In a further embodiment, it is also possible to calcine the lithium titanium mixed oxide, then to store it, e.g. under exclusion of water, and to grind it only shortly before the use to produce electrodes or solid electrolytes in an atmosphere with a dew point <−50° C. Alternatively, the lithium titanium mixed oxide ground in the atmosphere with a dew point <−50° C. can be processed directly after the step of grinding at the end of the production chain or stored in an atmosphere with a dew point <−50° C.

The step of grinding the mixture in an atmosphere with a dew point <−50° C. according to the method of the embodiments described here makes it possible for less water to be physisorbed on the surface of the lithium titanium mixed oxide, and also prevents a chemisorption of the physisorbed water. The lithium-ion batteries produced with the lithium titanium mixed oxide according to the invention thereby display less gas formation and a more stable cycle behaviour than batteries until now.

In an embodiment of the method, during the grinding, an atmosphere which comprises at least one gas selected from an inert gas, such as argon, nitrogen and mixtures thereof with air, is used as atmosphere with a dew point <−50° C. (at room temperature). In addition, the atmosphere can have a dew point <−70° C. or a dew point of <−50° C. and can additionally be heated, e.g. to 70° C., which also additionally reduces the relative moisture. These embodiments of the invention lead to a particularly cycle-stable lithium titanium mixed oxide.

In the method according to an embodiment, lithium carbonate and/or a lithium oxide can be used as lithium compound. If this lithium compound is calcined with titanium dioxide and ground in an atmosphere with a dew point <−50° C., a lithium titanium spinel is obtained.

If, during the provision of the mixture in another embodiment of the method, an oxygen-containing phosphorus compound, for example a phosphoric acid, and an oxygen-containing aluminium compound, for example Al(OH)₃, are added to the mixture of titanium dioxide and the lithium compound, a lithium aluminium titanium phosphate is obtained as the lithium titanium mixed oxide.

In a further embodiment, during the provision of the mixture, carbon, e.g. elemental carbon, or a carbon compound, e.g. a precursor compound of so-called pyrocarbon, can additionally be added, whereby a lithium titanium mixed oxide can be obtained which is provided with a carbon layer. The calcining preferably takes place under protective gas. The carbon layer can be obtained during the calcining for example from the carbon compound in the form of pyrocarbon. In other embodiments, the obtained product is saturated before or after the calcining with a solution of a carbon precursor compound, e.g. lactose, starch, glucose, sucrose, etc. and then calcined, whereupon the coating of carbon forms on the particles of the lithium titanium mixed oxide.

The lithium titanium composite oxide according to the method of further embodiments can comprise Li₂TiO₃ and TiO₂. Alternatively, the lithium titanium composite oxide can comprise Li₂TiO₃ and TiO₂ in which the molar ratio of TiO₂ to Li₂TiO₃ lies in a range of from 1.3 to 1.85.

In addition, in the method according to some embodiments, the provision of the mixture can comprise an additional grinding of the mixture, regardless of the atmosphere in which the grinding takes place, and/or a compaction of the mixture. Through the former, particularly fine-particle lithium titanium mixed oxide is obtained after running through the method, as two grinding steps take place. A compaction of the mixture can take place as mechanical compaction, e.g. by means of a roller compactor or a tablet press. Alternatively, however, a rolling granulation, build-up granulation or moist granulation can also be carried out. In the method according to embodiments, the calcining can furthermore take place at a temperature of from 700° C. to 950° C.

In a further embodiment, the grinding of the mixture is carried out in an atmosphere with a dew point <−50° C. with a jet mill. According to the invention, the jet mill grinds the particles of the mixture in a gas stream of the atmosphere with a dew point <−50° C. The principle of the jet mill is based on the particle-particle collision in the high-speed gas stream. According to the invention, the high-speed gas stream is produced from the atmosphere with a dew point <−50° C., for example compressed air or nitrogen.

The ground product is fed to this atmosphere and accelerated to high speeds via suitable nozzles. In the jet mill, the atmosphere is accelerated by the nozzles so strongly that the particles are entrained, and strike one another and are ground against each other in the focal point of nozzles directed towards each other. This grinding principle is suitable for the comminution of very hard materials, such as aluminium oxide. As, inside the jet mill, the interaction of the particles with the wall of the mill is slight, finely comminuted or ground particles of the lithium titanium mixed oxide with minimal contamination are obtained. Because the gas stream used for the grinding in the jet mill also has a dew point <−50° C., the obtained mixed oxide contains very little moisture or water or is substantially free therefrom. After the grinding of the mixture, a separation of the ground product from coarse particles can take place in the jet mill by means of a cyclone separator, wherein the coarser particles can be returned to the grinding process.

In an embodiment of the method, the mixing is carried out in the atmosphere with a dew point <−50° C. with a duration of from approximately 0.5 to 1.5 hours, preferably 1 hour, and/or at a temperature of from approximately −80 to 150° C. for the production of the lithium titanium mixed oxide. By regulating the duration of the grinding and/or the temperature during the grinding, the fine-particle nature of the lithium titanium mixed oxide or the moisture level of the atmosphere in which the mixture is ground can be adjusted. For example, the grinding can be carried out at a throughput of approximately 20 kg/h in a packed bed of 15-20 kg in a 200AFG-type air-jet mill from Alpine, thus for approximately 1 hour. Grinding can be carried out with cold nitrogen, e.g. at a temperature of up to less than −80° C., or with superheated steam at a temperature >120° C. Grinding can alternatively be carried out with air the temperature of which can be adjusted in a range of from 0° C. to almost 100° C. For example, the grinding air with a dew point of −40° C. can be heated to 70° C. The relative moisture thereby falls and corresponds to that of air with a dew point of approximately −60° C. at room temperature.

A further embodiment of the present invention relates to a lithium titanium mixed oxide which can be obtained by a method according to one of the embodiments described here. A further embodiment relates to a lithium titanium mixed oxide with a water content ≦300 ppm. Another embodiment relates to a lithium titanate with a water content ≦800 ppm, preferably ≦300 ppm. Such lithium titanium mixed oxides can be obtained by the method described here according to embodiments.

According to further embodiments of the invention, the lithium titanium mixed oxide can be selected from lithium titanium oxide, lithium titanate and lithium aluminium titanium phosphate. Lithium titanates here can be doped or non-doped lithium titanium spinels of the Li₁₊ₓTi₂₋ₓO₄ type with 0≦x≦⅓ of the space group Fd3m and all mixed titanium oxides of the generic formula LiₓTi_{y}O(0≦x,y≦1), in particular Li₄Ti₅O₁₂ (lithium titanium spinel). The lithium aluminium titanium phosphate can be Li₁₊ₓTi₂₋ₓAlₓ(PO₄)₃, wherein x≦0.4.

According to some embodiments of the present invention, the lithium titanium mixed oxide can contain 300 ppm or less water which is bonded by chemisorption or reversible chemisorption. According to other embodiments, the lithium titanium mixed oxide can contain 800 ppm or less water which is bonded by chemisorption or reversible chemisorption, in particular if the lithium titanium mixed oxide is a lithium titanate, e.g. Li₄Ti₅O₁₂. In addition, the lithium titanium mixed oxide according to the invention can be substantially free from water bonded by chemisorption or reversible chemisorption.

In further embodiments, the lithium titanium mixed oxide is non-doped or is doped with at least one metal, selected from Mg, Nb, Cu, Mn, Ni, Fe, Ru, Zr, B, Ca, Co, Cr, V, Sc, Y, Al, Zn, La and Ga. Preferably, the metal is a transition metal. A doping can be used in order to achieve a further increased stability and cycle stability of the lithium titanium mixed oxide when used in an anode. In particular, this is achieved if the doping metal ions are incorporated into the lattice structure individually or several at a time. The doping metal ions are preferably present in a quantity of from 0.05 to 3 wt.-% or 1 to 3 wt.-%, relative to the whole mixed lithium titanium mixed oxide. The doping metal cations can occupy either the lattice positions of the titanium or of the lithium. For example, an oxide or a carbonate, acetate or oxalate can additionally be added to the lithium compound and the TiO₂ as metal compound of the doping metal.

According to further embodiments, the lithium titanium mixed oxide can furthermore contain a further lithium oxide, e.g. a lithium transition metal oxo compound. If such a lithium titanium mixed oxide is used in an electrode of a secondary lithium-ion battery, the battery has a particularly favourable cycle behaviour.

In another embodiment, as has already been explained above in respect of the method according to some embodiments, the lithium titanium mixed oxide comprises a carbon layer or, more precisely, the particles of the lithium titanium mixed oxide have a carbon coating. Such a lithium titanium mixed oxide is suitable in particular for use in an electrode of a battery, and enhances the current density and the cycle stability of the electrode.

The lithium titanium mixed oxide according to the invention is used in an embodiment as material for an electrode, an anode and/or a solid electrolyte for a secondary lithium-ion battery.

In an anode for a secondary lithium-ion battery, according to a further embodiment, the lithium titanium mixed oxide is a doped or non-doped lithium titanium oxide or a doped or non-doped lithium titanate, e.g. Li₄Ti₅O₁₂, of embodiments described here.

If the lithium titanium mixed oxide of the above-described embodiments is a doped or non-doped lithium titanium metal phosphate or a doped or non-doped lithium aluminium titanium phosphate, it is suitable for a solid electrolyte for a secondary lithium-ion battery. Thus, an embodiment of the invention relates to a solid electrolyte for a secondary lithium-ion battery which contains such a lithium titanium mixed oxide.

Furthermore, the invention relates to a secondary lithium-ion battery which comprises an anode according to embodiments, for example made of lithium titanium mixed oxide which is a doped or non-doped lithium titanium oxide or a doped or non-doped lithium titanate. Moreover, the secondary lithium-ion battery can contain a solid electrolyte which contains a lithium titanium mixed oxide which is a doped or non-doped lithium titanium metal phosphate or a doped or non-doped lithium aluminium titanium phosphate according to embodiments.

Further features and advantages result from the following description of examples of embodiments and from the dependent claims.

All non-mutually exclusive features described here of embodiments can be combined with one another. Elements of one embodiment can be used in the other embodiments without further mention. Embodiments of the invention will now be described in more detail in the following examples with reference to figures, without being regarded as limiting.

### BRIEF DESCRIPTION OF THE DRAWINGS

FIG. 1 is an x-ray diffraction diagram for a lithium titanium mixed oxide according to Example 1.

FIG. 2 is an x-ray diffraction diagram for a lithium titanium mixed oxide according to Example 2.

### EMBODIMENTS EXAMPLES

1. Measurement Methods

The BET surface area was determined according to DIN 66131 (DIN-ISO 9277). Micromeritics Gemini V or Micromeritics Gemini VII were used as measuring devices for this.

The particle-size distribution was determined according to DIN 66133 by means of laser granulometry with a Malvern Hydro 20005 device.

The X-ray powder diffractogram (XRD) was measured with a Siemens XPERTSYSTEM PW3040/00 and DY784 software.

The water content was analysed with Karl Fischer titration. The sample was baked at 200° C. and the moisture was condensed and determined in a receiver which contained the Karl Fischer analysis solution.

### Example 1

### Production of Li_{1.3}Al_{0.3}Ti_{1.7}(PO₄)₃

1037.7 g orthophosphoric acid (85%) was introduced into a reaction vessel. A mixture of 144.3 g Li₂CO₃, 431.5 g TiO₂ (in anatase form) and 46.8 g Al(OH₃) (gibbsite) was added slowly via a fluid channel accompanied by vigorous stirring with a Teflon-coated anchor stirrer. As the Li₂CO₃ with the phosphoric acid reacted off accompanied by strong foaming of the suspension because of the formation of CO₂, the admixture was added very slowly over a period of from 1 to 1.5 hours.

The mixture was then heated to 225° C. in an oven and left at this temperature for two hours. A hard, friable crude product, only partly removable from the reaction vessel with difficulty, forms. The complete solidification of the suspension from liquid state via a rubbery consistency took place relatively quickly. However, e.g. a sand or oil bath can also be used instead of an oven.

The solid mixture was then heated from 200 to 900° C. within six hours, at a heating interval of 2° C. per minute. Then, the product was sintered at 900° C. for 24 hours and calcined.

The calcined mixture was then finely ground for approximately 4 hours in a jet mill in an atmosphere with a dew point <−50° C. and with a temperature of 25° C. at approximately 20 kg packed bed with a throughput of approximately 7 kg per hour. The Alpine 200AFG from Hosokawa Alpine, which makes it possible to adjust the temperature and the gas stream, was used as jet mill. The jet mill was operated at 11500 rpm.

### Comparison Example 1

To produce a comparison example 1, the same starting materials were subjected to the same production method as in Example 1, but with grinding of the calcined mixture in a jet mill with undried air under the usual technical conditions (untreated compressed air from the compressor of the jet mill, dew point approximately 0° C.). The sintering was carried out here for 12 h at 950° C. and a lithium aluminium titanium phosphate was obtained.

Finally, the water content of the Li_{1.3}Al_{0.3}Ti_{1.7}(PO₄)₃ obtained according to Example 1 and of comparison example 1 was determined and a value of 250 ppm was found for the product according to the invention and a value of 1500 ppm for comparison example 1.

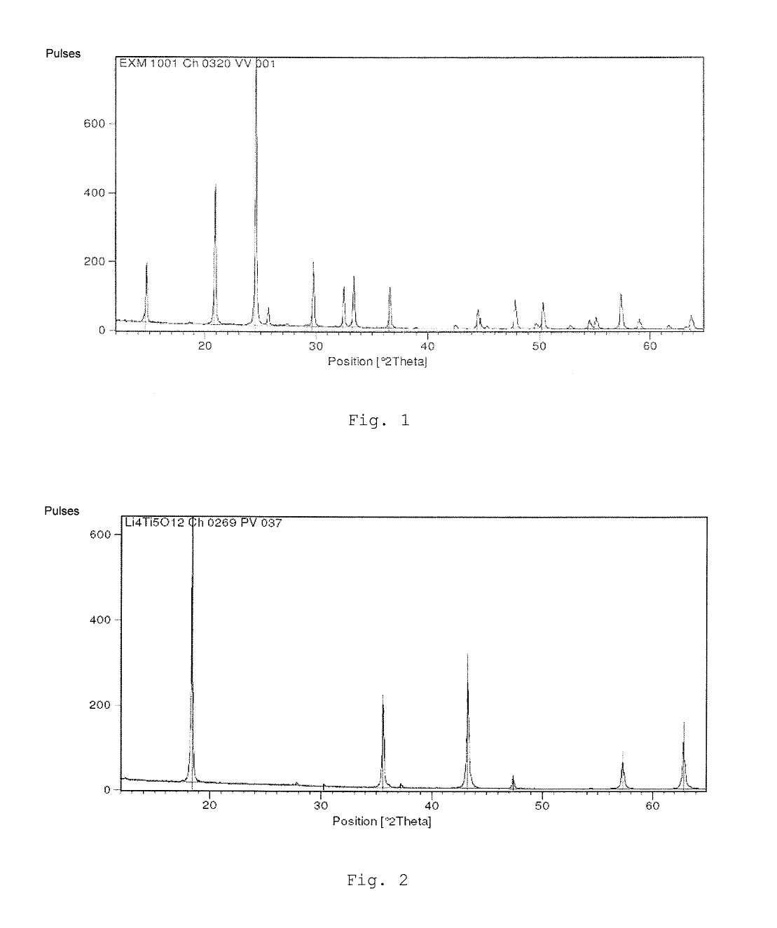

The determination of the BET surface area of Example 1 yielded approximately 3 m²/g. The particle-size distribution of Example 1 amounted to D₅₀=1.56 μm. The XRD measurement of FIG. 1 for Example 1 showed phase-pure Li_{1.3}Al_{0.3}Ti_{1.7}(PO₄)₃.

The structure of the product Li_{1.3}Al_{0.3}Ti_{1,7}(PO₄)₃ obtained according to the invention is similar to a so-called NASiCON (Na⁺ superionic conductor) structure (see Nuspl et al. J. Appl. Phys. Vol. 06, No. 10, p. 5484 et seq. (1999)). The three-dimensional Li⁺ channels of the crystal structure and a simultaneously very low activation energy of 0.30 eV for the Li migration in these channels bring about a high intrinsic Li ion conductivity. The Al doping scarcely influences this intrinsic Li⁺ conductivity, but reduces the Li ion conductivity at the grain boundaries.

In a variant of Example 1, Li_{1.3}Al_{0.3}Ti_{1.7}(PO₄)₃ can also be synthesized in that, after the end of the addition of the mixture of lithium carbonate, TiO₂ and Al(OH)₃, the white suspension is transferred into a vessel with anti-adhesion coating, for example into a vessel with Teflon walls. The removal of the hardened intermediate product is thereby made much easier. In a modification of the method according to Example 1, a first calcining of the dry mixture over 12 hours after cooling to room temperature can furthermore be carried out, followed by a second calcining over a further 12 hours at 900° C. In each case an Li_{1.3}Al_{0.3}Ti_{1.7}(PO₄)₃ is obtained which also displayed a water content below 300 ppm.

### Example 2

### Production of Li₄Ti₅O₁₂

16 kg TiO₂ and 6 kg (air jet ground) Li₂CO₃ were introduced into a stirring device. For this, a “Lödige” type mixer was used. Approximately 440 g of the above-described composition of the starting materials was stirred for 1 h without cooling at a power consumption of 1 kW. The thus-obtained mixture was then sintered for 17 h at 950° C. and calcined. Finally, the calcined mixture was finely ground for one hour in the Alpine 200AFG jet mill from Hosokawa Alpine in an air atmosphere with a dew point <−50° C. and a temperature of 50° C. Thus, a lithium titanium spinel according to the invention was obtained.

### Comparison Example 2

A comparison example 2 was obtained from the same starting materials and with the same production method as Example 2. The calcined mixture was ground in the same way as in comparison example 1. The sintering was carried out here for 12 h at 950° C. and a lithium titanium spinel was obtained.

The determination of the BET surface area of Example 2 yielded approximately 3 m²/g. The particle-size distribution of Example 2 amounted to D₅₀=1.96 μm. The XRD measurement of FIG. 2 for Example 2 showed phase-pure Li₄Ti₅O₁₂.

Finally, the water content of the Li₄Ti₅O₁₂ according to the invention obtained according to Example 2 and of comparison example 2 was determined and a value of 250 ppm was found for the Li₄Ti₅O₁₂ according to the invention and of 1750 ppm for comparison example 2.

### Example 3

Production of carbon-containing Li₄Ti₅O₁₂ variant 1 9.2 kg LiOH.H₂O was dissolved in 45 l water and then 20.8 kg TiO₂ was added. Then, 180 g lactose was added, with the result that a batch with 60 g lactose/kg LiOH+TiO₂ was run. The mixture was then spray-dried in a Nubilosa spray dryer at a starting temperature of approximately 300° C. and an end temperature of 100° C. First, porous spherical aggregates of the order of several micrometres formed.

Then, the thus-obtained product was calcined at 750° C. for 5 h under a nitrogen atmosphere.

Finally, the calcined mixture was finely ground for one hour in the jet mill in an air atmosphere with a dew point <−50° C. and a temperature of 25° C.

The water content of the thus-produced carbon-containing Li₄Ti₅O₁₂ according to Example 3 was 278 ppm.

### Comparison Example 3

As comparison example 3, carbon-containing Li₄Ti₅O₁₂ was produced with the same starting materials and the same production method. The calcined mixture was ground in the same way as in comparison example 1. The sintering was carried out here for 5 h at 750° C.

The water content of the thus-produced carbon-containing Li₄Ti₅O₁₂ of comparison example 3 was 1550 ppm.

### Example 4

### Production of Carbon-Containing Li₄Ti₅O₁₂ Variant 1

9.2 kg LiOH.₂O was dissolved in 45 l water and then 20.8 kg TiO₂ was added. The mixture was then spray-dried in a Nubilosa spray dryer at a starting temperature of approximately 300° C. and an end temperature of 100° C. First, porous spherical aggregates of the order of several micrometres formed.

The obtained product was saturated with 180 g lactose in 1 l water and then calcined at 750° C. for 5 h under a nitrogen atmosphere.

Finally, the calcined mixture was finely ground for one hour in the jet mill in an air atmosphere with a dew point <−50° C. and a temperature of 25° C.

The water content of the thus-produced carbon-containing Li₄Ti₅O₁₂ according to Example 4 was 289 ppm.

### Comparison Example 4

As comparison example 4, carbon-containing Li₄Ti₅O₁₂ was produced with the same starting materials and the same production method. The calcined mixture was ground in the same way as in comparison example 1. The sintering was carried out here for 5 h at 750° C.

The water content of the thus-produced carbon-containing Li₄Ti₅O₁₂ of comparison example 4 was 1650 ppm.

### Example 5

This example relates to lithium titanate Li₄Ti₅O₁₂ which was obtained by the thermal reaction of a composite oxide containing Li₂TiO₃ and TiO₂, wherein the molar ratio of TiO₂ to Li₂TiO₃ lies in a range of from 1.3 to 1.85. For this, reference is made to patent application DE 10 2008 026 580.2, the full extent of which is contained here by reference.

LiOH.H₂O was initially dissolved in distilled water and heated to a temperature of 50 to 60° C. Once the lithium hydroxide was fully dissolved, a quantity of solid TiO₂ in anatase modification (obtainable from Sachtleben), wherein the quantity was enough to form the composite oxide 2 Li₂TiO₃/3 TiO₂, was added to the 50 to 60° C. hot solution accompanied by constant stirring. After homogeneous distribution of the anatase, the suspension was placed in an autoclave, wherein the conversion then took place under continuous stirring at a temperature of 100° C. to 250° C., typically at 150 to 200° C., for a period of approximately 18 hours.

Parr autoclaves (Parr 4843 pressure reactor) with double stirrer and a steel heating coil were used as autoclaves.

After the end of the reaction, the composite oxide 2 Li₂TiO₃/3 TiO₂ was filtered off. After washing the filter cake, the latter was dried at 80° C. The composite oxide 2 Li₂TiO₃/3 TiO₂ was then calcined at 750° C. for 5 h.

Finally, the calcined mixture was finely ground for one hour in the jet mill in an air atmosphere with a dew point <−50° C. and a temperature of 25° C.

The water content of the thus-produced carbon-containing Li₄Ti₅O₁₂ according to Example 5 was 300 ppm.

### Comparison Example 5

As comparison example 5, carbon-containing Li₄Ti₅O₁₂ was produced with the same starting materials and the same production method. The calcined mixture was ground in the same way as in comparison example 1. The sintering was carried out here for 5 h at 750° C.

The water content of the thus-produced carbon-containing Li₄Ti₅O₁₂ of comparison example 5 was 1720 ppm.

1. A method for producing a lithium titanium mixed oxide, comprising the steps of:
providing of a mixture of titanium dioxide and a lithium compound or a lithium titanium composite oxide;
calcining the mixture or of the lithium titanium composite oxide; and
grinding the mixture or the lithium titanium composite oxide in an atmosphere with a dew point <−50° C. after the calcining.

2. The method according to claim 1, wherein an atmosphere comprising at least one gas selected from protective gas, inert gas, nitrogen and air, and/or an atmosphere with a dew point <−70° C. is used as the atmosphere.

3. The method according to claim 1, wherein providing of the mixture comprises adding an oxygen-containing phosphorus compound and an oxygen-containing aluminium compound.

4. The method according to claim 1,
wherein providing the mixture comprises adding carbon, a carbon compound or a precursor compound of pyrocarbon, grinding and/or compaction of the mixture; and/or
wherein the calcining takes place under protective gas.

5. The method according to claim 1, wherein lithium carbonate and/or a lithium oxide is used as lithium compound; and/or wherein the lithium titanium composite oxide comprises Li₂TiO₃ and TiO₂ or comprises Li₂TiO₃ and TiO₂ in which the molar ratio of TiO₂ to Li₂TiO₃ lies in a range of from 1.3 to 1.85; and/or wherein the calcining takes place at a temperature of from 700° C. to 950° C.

6. The method according to claim 1, wherein the grinding is carried out with a jet mill.

7. The method according to claim 1, wherein the grinding is carried out over a duration of from 0.5 to 1.5 hours and/or at a temperature of from −80 to 150° C.

8. Lithium titanium mixed oxide, obtained by a method according to claim 1.

9. The lithium titanium mixed oxide according to claim 8, wherein the lithium titanium mixed oxide has a water content ≦300 ppm; or wherein the lithium titanium mixed oxide is a lithium titanate with a water content ≦800 ppm.

10. The lithium titanium mixed oxide according to claim 9, wherein the lithium titanium mixed oxide is selected from lithium titanium oxide, lithium titanate, and lithium aluminium titanium phosphate.

11. The lithium titanium mixed oxide according to one of claim 8, containing 300 ppm or less water or 800 ppm or less water, which is bonded by chemisorption or reversible chemisorption; and/or wherein the lithium titanium mixed oxide is substantially free from water bonded by chemisorption or reversible chemisorption.

12. The lithium titanium mixed oxide according to claim 8, wherein the lithium titanium mixed oxide is non-doped or doped with at least one metal, selected from Mg, Nb, Cu, Mn, Ni, Fe, Ru, Zr, B, Ca, Co, Cr, V, Sc, Y, La, Zn, Al, and Ga, and/or contains a further lithium oxide.

13. The lithium titanium mixed oxide according to claim 8, further comprising a carbon coating.

14. (canceled)

15. An anode-for a secondary lithium-ion battery, containing the lithium titanium mixed oxide according to claim 8, wherein the lithium titanium mixed oxide is a doped or non-doped lithium titanium oxide or a doped or non-doped lithium titanate.

16. A solid electrolyte for a secondary lithium-ion battery, containing the lithium titanium mixed oxide according to claim 8, wherein the lithium titanium mixed oxide is a doped or non-doped lithium titanium metal phosphate or a doped or non-doped lithium aluminium titanium phosphate.

17. A secondary lithium-ion battery comprising an anode according to claim 15.

18. A secondary lithium-ion battery comprising a solid electrolyte according to claim 16.
